(19) United States
(12) Patent Application Publication
(10) Pub. No.: US 2008/0047440 A1
(43) Pub. Date: Feb. 28, 2008

(54) Shish kabob unit

(76) Inventor: Edward Scott Carlson, Delmont, PA (US)

Correspondence Address: JAMES RAY & ASSOCIATES, 2640 PITCAIRN ROAD, MONROEVILLE, PA, 15146, US

(21) Appl. No.: 11/810,816

(22) Filed: Jun. 7, 2007

Related U.S. Application Data
(60) Provisional application No. 60/811,693, filed on Jun. 7, 2006.

(51) Int. Cl. A47J 37/04

(52) U.S. Cl. 99/421 A; 99/421 H

(57) ABSTRACT

An apparatus for at least one of supporting, containing and rotating a pre-selected food product. The apparatus comprises a food contacting member having each of a first predetermined shape and a first predetermined length for one of receiving such pre-selected food product thereon and containing such pre-selected food product therein. There is at least one handle member having a second predetermined shape and a second predetermined length and a means engageable with a first end of the food contacting member and a first end of the handle member for removably engaging the at least one handle member with the food contacting member for facilitating at least one of placing and removing the food contacting member onto and from respectively a heat source and intermittently rotating such food contacting member for a predetermined degree over such heat source, such means being one of manually operated and power driven.

### CROSS REFERENCE TO RELATED APPLICATIONS

This application is closely related to and claims priority benefit from U.S. Provisional Application Ser. No. 60/811,693 filed Jun. 7, 2006.

### FIELD OF THE INVENTION

The present invention relates, in general, to a shish kabob unit, and, more particularly, the present invention relates to at least one hand held wand that engages with an apparatus that holds or contains a food product for cooking and which provides a safe means of placing, rotating and removing food products from a cooking surface.

### BACKGROUND OF THE INVENTION

In our present society cooking on a backyard grill is one of the most popular methods of preparing food, especially in the summertime. Traditional methods of cooking on the grill includes the placement of food or a container holding the food directly onto the cooking surface and then using tongs, spatulas, forks, and gloves for rotating the food and then removing the food product. Another method of cooking involves inserting a shaft, generally a pointed shaft, through the food and then placing the shaft directly on the cooking surface as with shish kabobs. Yet another method for cooking on the grill is to insert a shaft through the food and have a manual or mechanically driven means for rotating the food as with rotisseries.

Although the merits of each method of cooking a food product could be discussed, for the sake of clarity the remainder of the discussion will focus on shish kabobs. Existing methods for cooking shish kabobs consist of placing meat and vegetables on flat or round skewers that traditionally have a point on one end and a round loop on the opposite end, then placing the food directly on the cooking surface. The methods used for rotating a kabob skewer that is placed directly on a grilling surface is limited at best but one usually places a glove or mitten on one hand and uses a set of tongs or a fork in the other hand to place, rotate and remove the food. When positioning the food for cooking what often happens is that while reaching across the cooking surface an individual could potentially get burnt, especially if the grill is flaming up due to a grease fire. Another common problem that occurs while cooking is that the food sticks to the cooking surface making it difficult to lift and rotate the skewer in order to cook the other side. Still another problem that frequently exists with the design of existing art involves the placement of the food on the skewer.

Thus, it can be seen from the above discussion that it would be advantageous for persons that do considerable cooking on the grill if there were an apparatus which would hold or contain the food product for cooking and which would provide a safe means for placing, rotating and removing food products from a cooking surface.

### SUMMARY OF THE INVENTION

In a first aspect the present invention provides an apparatus for at least one of supporting, containing and rotating a pre-selected food product. The apparatus comprises a food contacting member having each of a first predetermined shape and a first predetermined length for one of receiving such pre-selected food product thereon and containing such pre-selected food product therein. There is at least one handle member having a second predetermined shape and a second predetermined length and a means engageable with a first end of the food contacting member and a first end of the handle member for removably engaging the at least one handle member with the food contacting member for facilitating at least one of placing and removing the food contacting member onto and from respectively a heat source and intermittently rotating such food contacting member for a predetermined degree over such heat source, such means being one of manually operated and power driven.

In a second aspect there is provided an apparatus for at least one of supporting, containing and rotating a pre-selected food product. The apparatus comprises a rod like member having each of a first predetermined shape and a first predetermined length for one of receiving such pre-selected food product thereon. Such rod like member having a fixed end portion and a removable end portion to facilitate placing such pre-selected food product onto the rod like member. There is at least one handle member having a second predetermined shape and a second predetermined length and a means engageable with the fixed end portion of the rod like member and a first end of the handle member for removably engaging the at least one handle member with the fixed end of the rod like member. This will facilitate at least one of placing and removing the rod like member onto and from respectively a heat source and intermittently rotating the rod like member for a predetermined degree over such heat source. The means is power driven by an electrically operated power assist means which includes a power source connected to a motor means and a switch means connected between the power source and the motor means for supplying and disrupting power to the motor means.

### OBJECTS OF THE INVENTION

It is, therefore, one of the primary objects of the present invention to provide an apparatus for cooking a food product on a grill, on a grate that is over a campfire or in or on an oven without getting burnt.

Another object of the present invention is to provide an apparatus which enables the user to easily place, rotate and remove a food product from a cooking surface.

Still another object of the present invention is to provide an apparatus that enables the food product to be cooked more evenly.

Yet another object of the present invention is to provide an apparatus that allows the food product to be cooked without sticking to the cooking surface.

Another object of the present invention is to provide an apparatus that allows the food product to be cooked at different heights from the cooking surface.

It is still another object of the present invention to provide an apparatus that allows for easy placement of the food on a skewer.

It is yet another object of the present invention to provide an apparatus that is power driven or manually operated.

Another object of the present invention is to provide an apparatus that uses a frame member that can hold a plurality of skewers that are ready for cooking.

Still another object of the present invention is to provide an apparatus that has different shaped baskets for holding the food product to be cooked.

Yet another object of the present invention is to provide an apparatus that has different shaped baskets to accommodate various shaped foods.

Another object of the present invention is to provide an apparatus that has a combination skewer and basket design.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention.

FIG. 2 is a top view of the apparatus shown in FIG. 1.

FIG. 3 is a perspective view of an embodiment of the invention showing a rod like member attached at one end thereof to a fixed member.

FIG. 4 is a perspective view of the rod like member shown in FIG. 3 showing the outer end of the fixed member.

FIGS. 5A and 5B are perspective views of the presently preferred removable end of the rod like member.

FIG. 5C is a side view of the presently preferred removable end of the rod like member.

FIG. 6 is a perspective view of the presently preferred embodiment of the rod like member.

FIG. 7 is a perspective view of an alternate embodiment of the rod like member.

FIG. 8 is a perspective view of a cone shape means for securing the rod like member to the block member by means of a friction fit.

FIG. 9 is a perspective view of the apparatus showing a connecting means for opposed ends of a pair of handles.

FIG. 10 is a perspective view of an embodiment of the invention wherein a rod like member and a basket member are combined for receiving food products thereon and for containing such food products therein.

FIG. 11 is a perspective view of the basket member according to a presently preferred embodiment of he invention.

FIG. 12 is a perspective view of a manually operated handle member for rotating such food containing member.

FIG. 13 is a side elevation view of taken across the lines of 13-13 of FIG. 12.

FIG. 14 is a top view of the manually operated handle member connected to the food containing means.

FIGS. 15B and 15D are perspective views illustrating frame like members for retaining a plurality of food containing members for placement on a cooking surface.

FIGS. 15A and 15C are side views illustrating frame like members for retaining a plurality of food containing members for placement on a cooking surface.

FIG. 16 is a top view of the apparatus illustrating an embodiment of the invention

FIG. 17A-D are perspective views of the food containing members illustrating various embodiments of the present invention.

FIG. 18 is a perspective view of the apparatus according to an alternate embodiment of the invention.

FIG. 19 is a perspective view of the power driven means according to one embodiment of the invention.

FIG. 20 is a perspective view of the power driven means according to an alternate embodiment of the invention.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

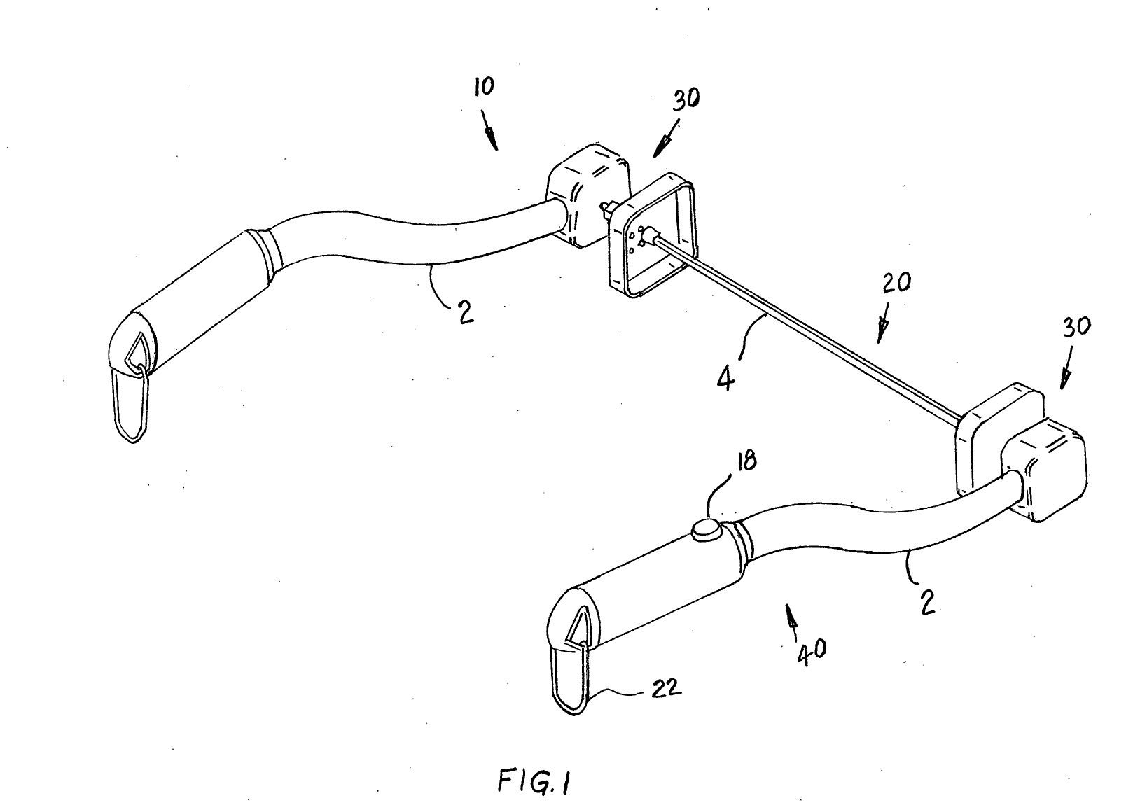

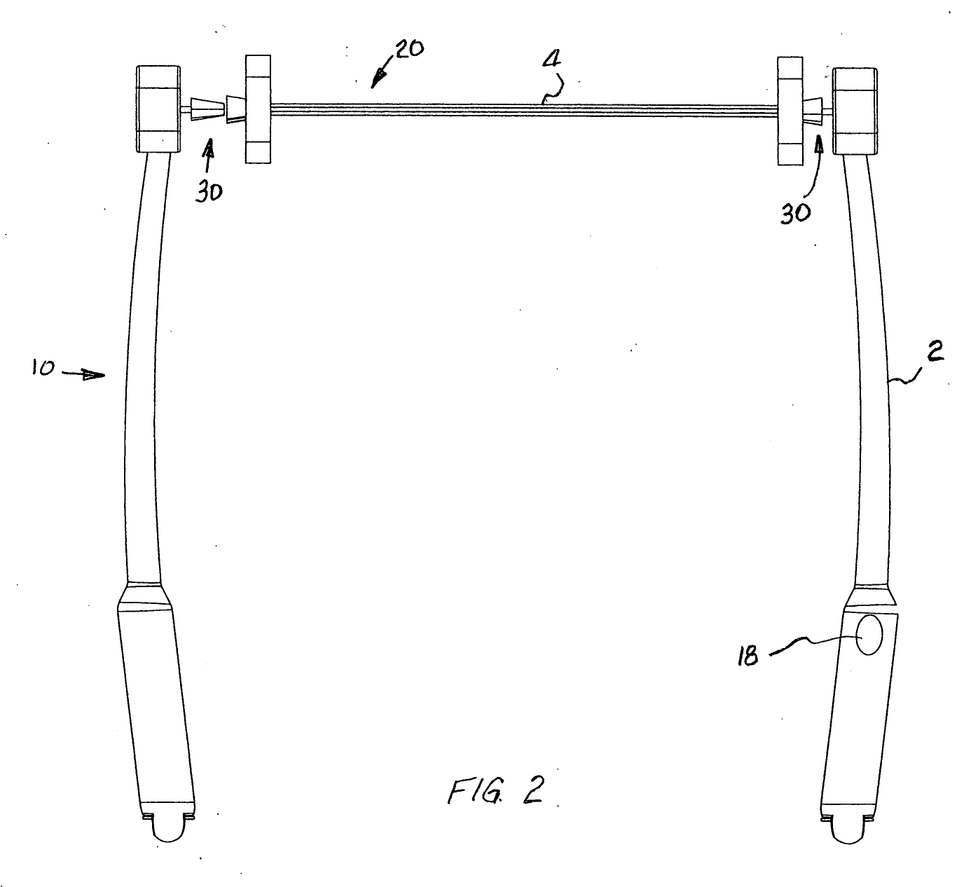

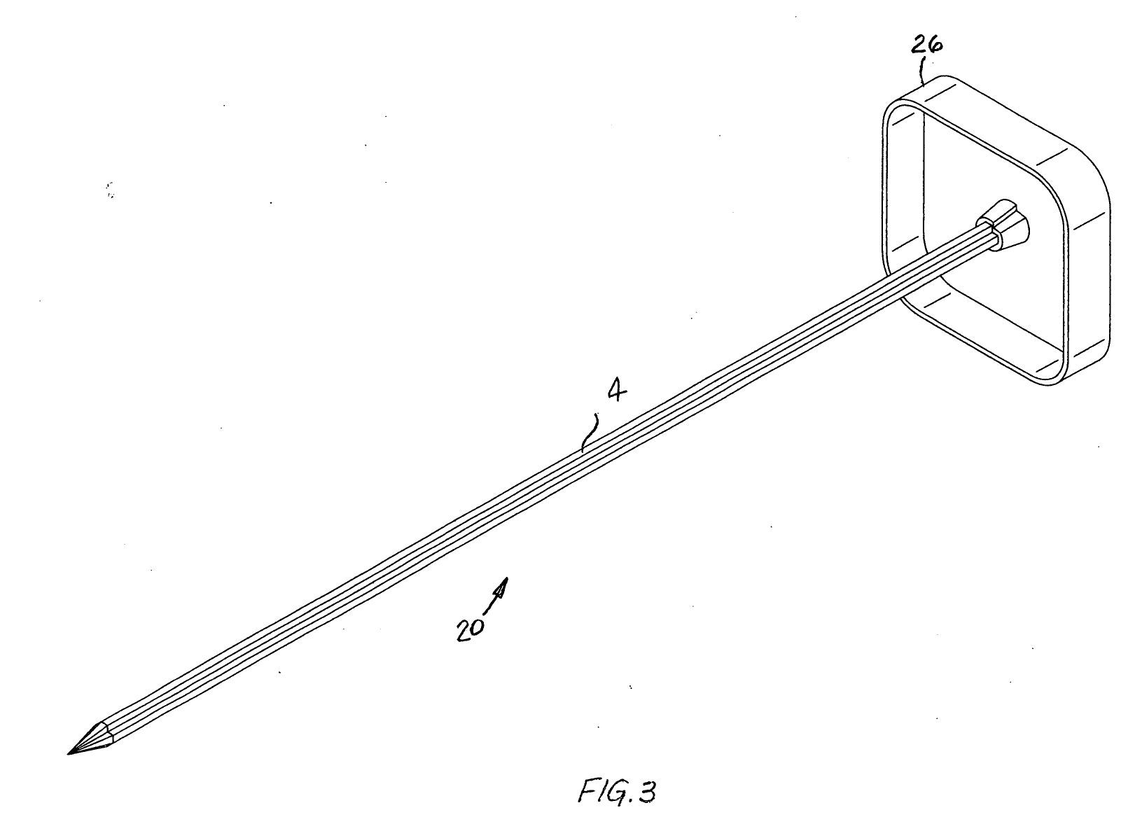

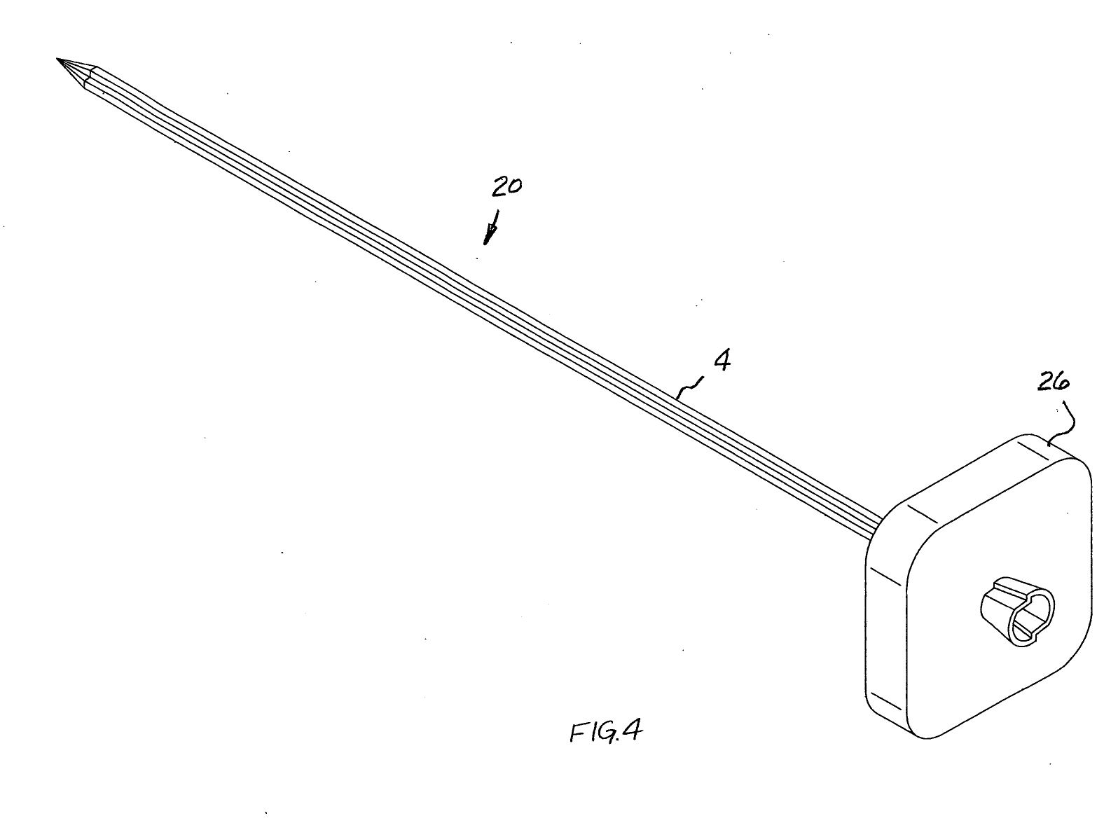

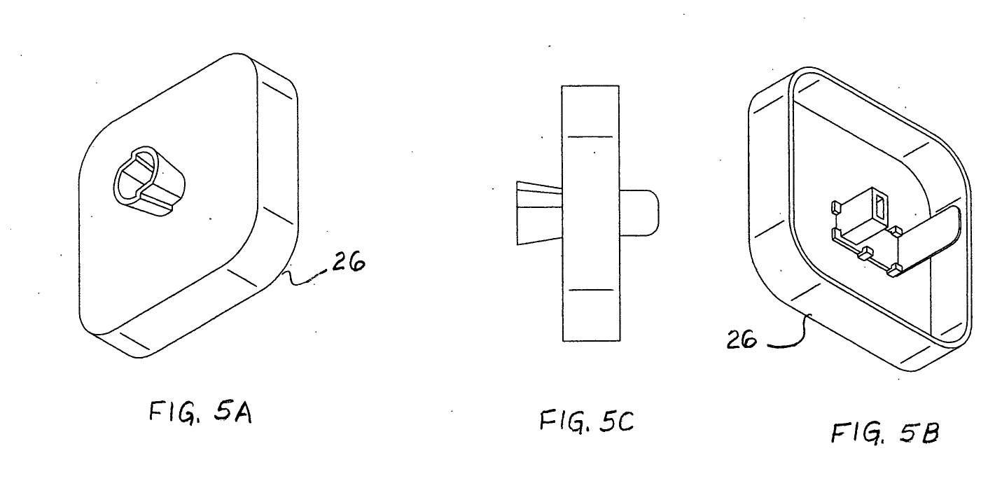

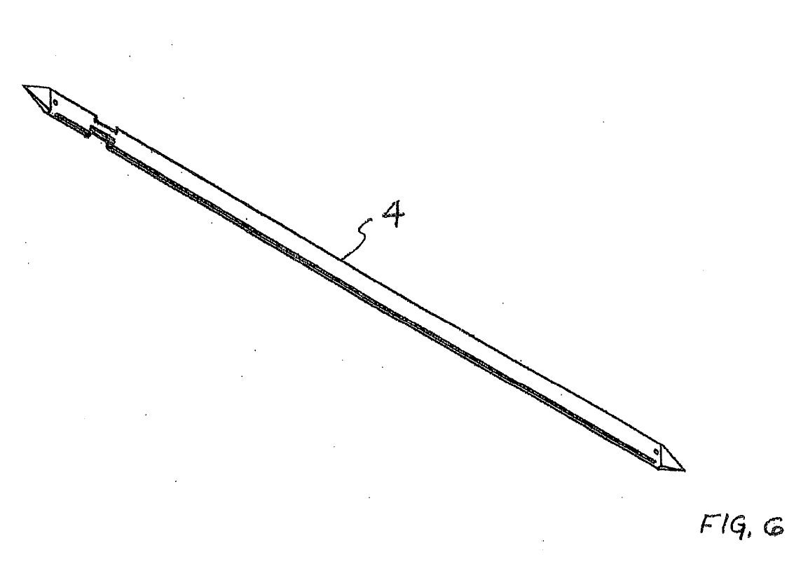

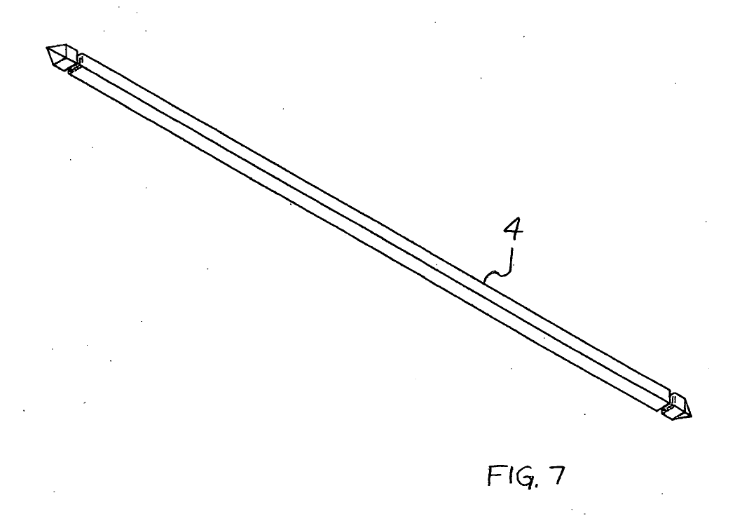

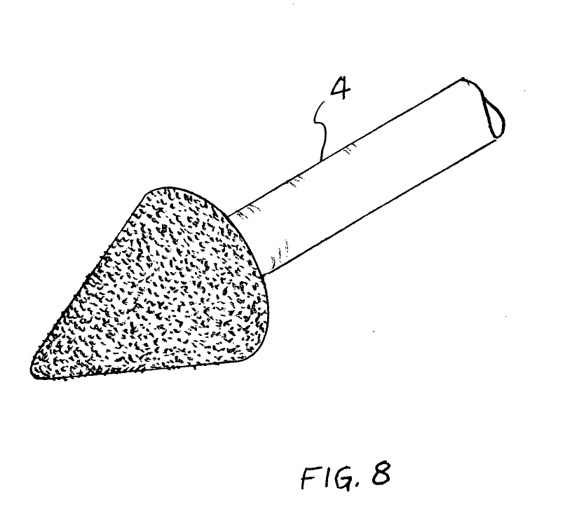

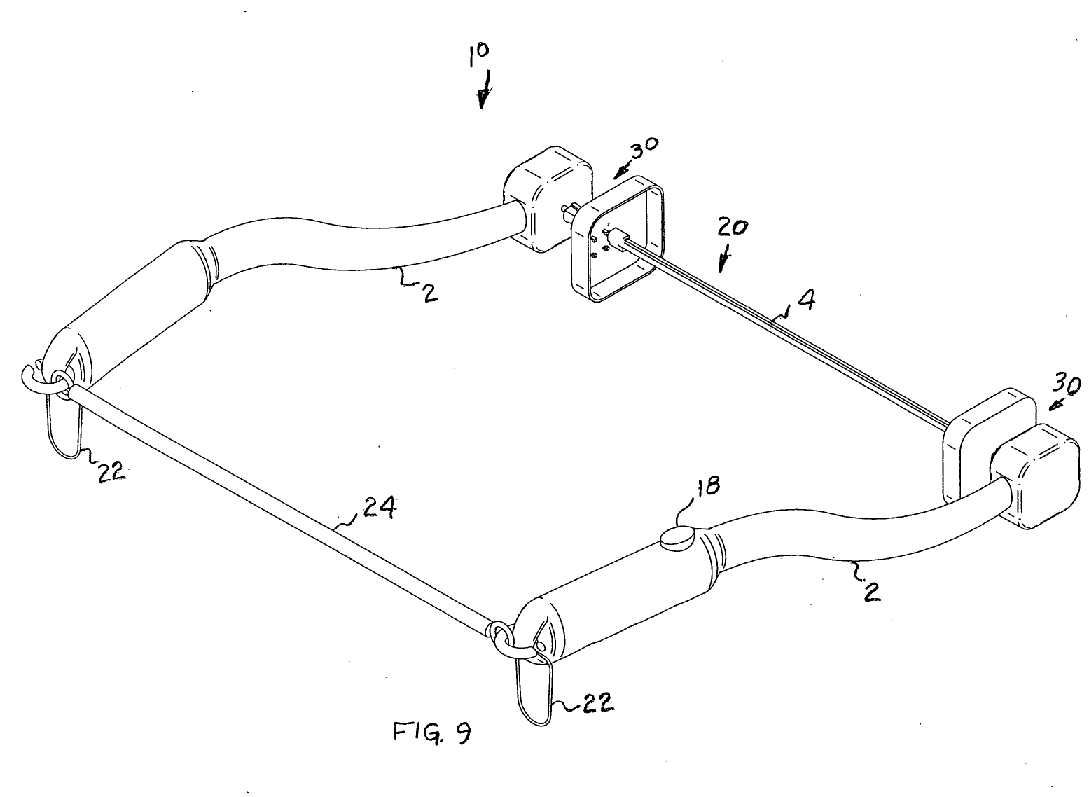

In a first aspect, as seen in FIG. 1, the present invention provides an apparatus, generally designated 10, for at least one of supporting, containing and rotating a pre-selected food product. The apparatus 10 comprises a food contacting member, generally designated 20, having each of a first predetermined shape and a first predetermined length for one of receiving such pre-selected food product thereon and containing such pre-selected food product therein. There is at least one handle member 2 having a second predetermined shape and a second predetermined length and a means, generally designated 30, that is engageable with a first end of the food contacting member 20 and a first end of the handle member 2 for removably engaging the at least one handle member 2 with the food contacting member 20 for facilitating at least one of placing and removing the food contacting member 20 onto and from respectively a heat source and intermittently rotating such food contacting member 20 for a predetermined degree over such heat source, such means 30 being one of manually operated and power driven.

Such food contacting member 20 is rotated by one of a mechanical means 12 and an electrical power assist means, generally designated 40, that is disposed at least one of on and in the handle member 2 for causing rotation of the food contacting member 20. The power assist means 40 is electrically operated and the apparatus 10 further includes a power source 14 connected to a motor means 16 and a switch means 18 connected between the power source 14 and the motor means 16 for supplying and disrupting power to motor means 16. It is presently preferred that such power source 14 is a battery and that such battery is rechargeable.

Such food contacting member 20 is one of a rod like member 4, a basket 6 and a combination rod like member 4 and a basket 6. Such apparatus 10 further includes a frame member 8, as seen in FIG. 15, having each of a third predetermined length and a first predetermined width for receiving thereon a predetermined plurality of food contacting members 20 to be placed over such heat source. Such frame member 8 includes a predetermined plurality of radially opposed cutouts 9 having a third predetermined shape disposed on each of the frame members 8 along the third predetermined length for receiving a plurality of such food contacting members 20. The third predetermined shape of such cutouts 9 is one of U and V-shaped.

In a preferred embodiment of the invention such at least one handle member 2 further includes a strap like member 22 that is attached to a second end of the handle member 2 for hanging such handle member 2 up when it is not in use. It is also preferred that such apparatus 10 includes a pair of handle members 2 that are removably engageable with a respective end of the food contacting member 20, one of the pair of handle members 2 has a free floating engagement with the respective end of the food contacting member 20.

In an alternate embodiment such apparatus 10 such pair of handle members 2 further include a cross member 24 that is pivotally attached to a second end thereof for assisting in positioning the pair of handle members 2 during engagement with the food contacting member 20.

The food contacting member 20 can be rotated an infinite amount. However, it is preferred that such predetermined degree of rotation of the food contacting member is one of 90, 180 and 270 degrees.

The means 30 that is engageable with a first end of the food contacting member 20 and a first end of the handle member 2 for removably engaging at least one handle member 2 from the food contacting member 20 includes at least one block like member 26 for engaging at least one end of the food contacting member in a cavity formed on a first side thereof and at least one of a protrusion and a cavity formed on and in respectively on a radially opposed second side thereof. The at least one of the protrusion and the cavity having a fourth predetermined shape and the handle member 2 includes a mating opposed one of an at least one of a protrusion and a cavity formed on a side thereof and having a substantially identical fourth predetermined shape.

The fourth predetermined shape is selected from the group consisting of generally conical, rectangular, oval, triangular, hexagonal, star and octagonal. It is presently preferred that such shape is generally conical. The second predetermined shape is selected from the group consisting of straight, curved and offset.

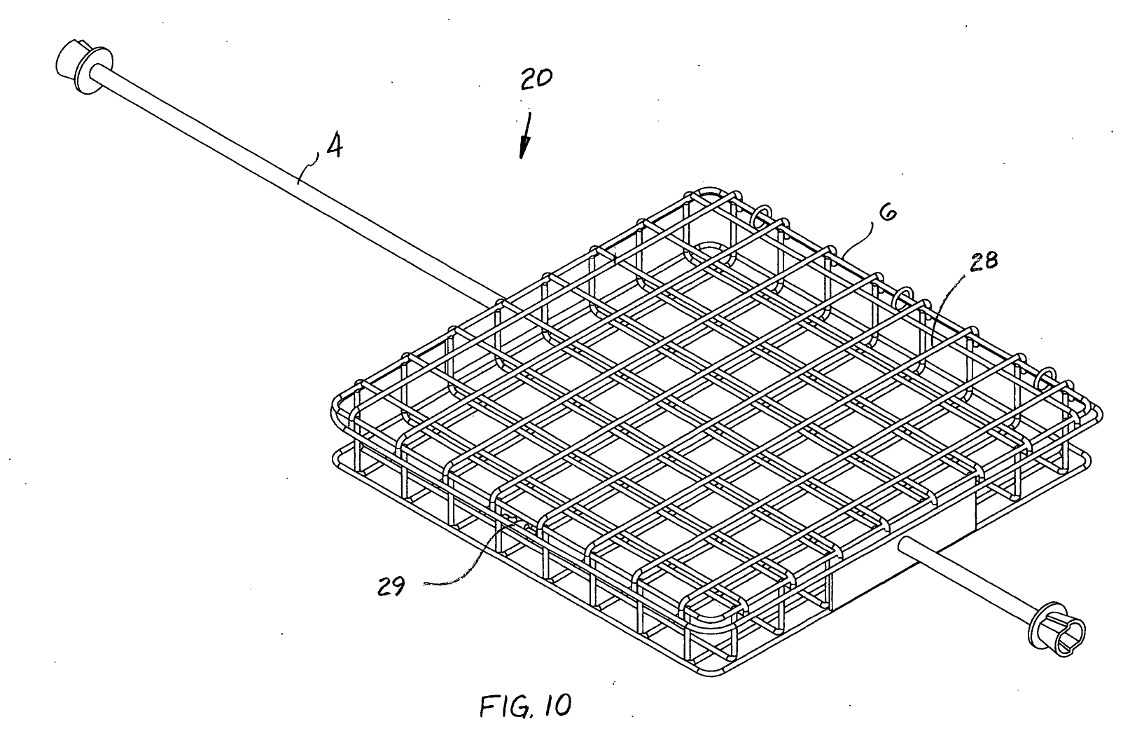

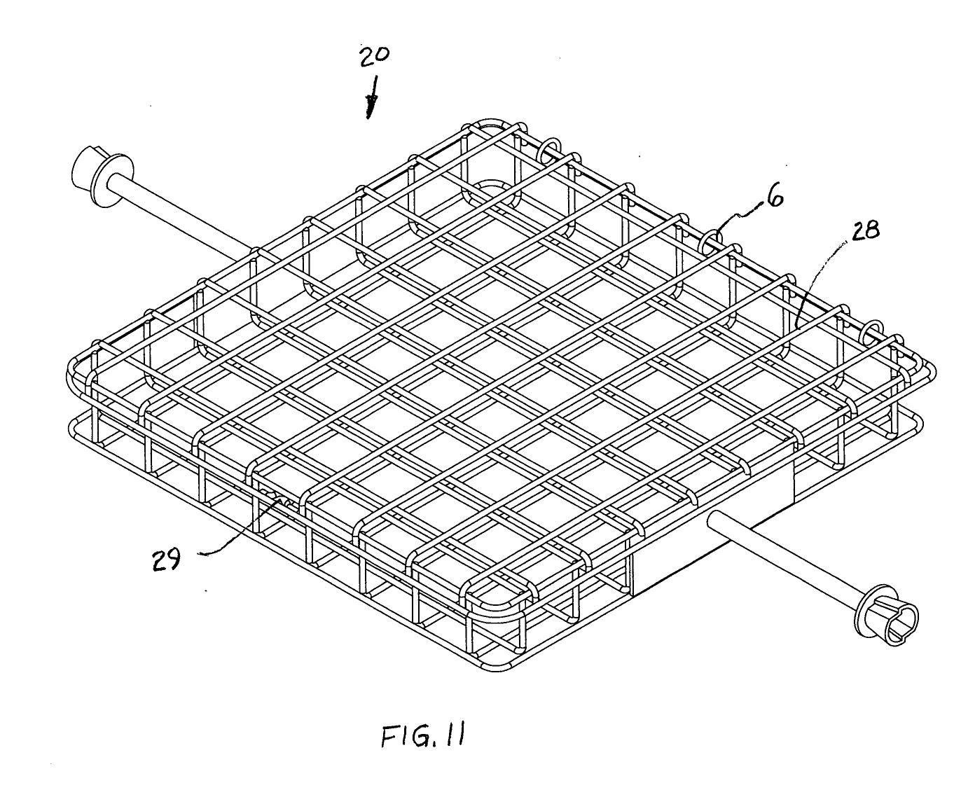

In the case where the food contacting member 20 is a basket member 6, such basket 6 has a fifth predetermined shape. As seen in FIGS. 10 and 11 such basket member 6 includes a lid member 28 that is hingedly connected thereto and there is a fastening means 29 for retaining the lid member 28 in a closed position during cooking. Such fifth predetermined shape of the basket member 28 is generally rectangular.

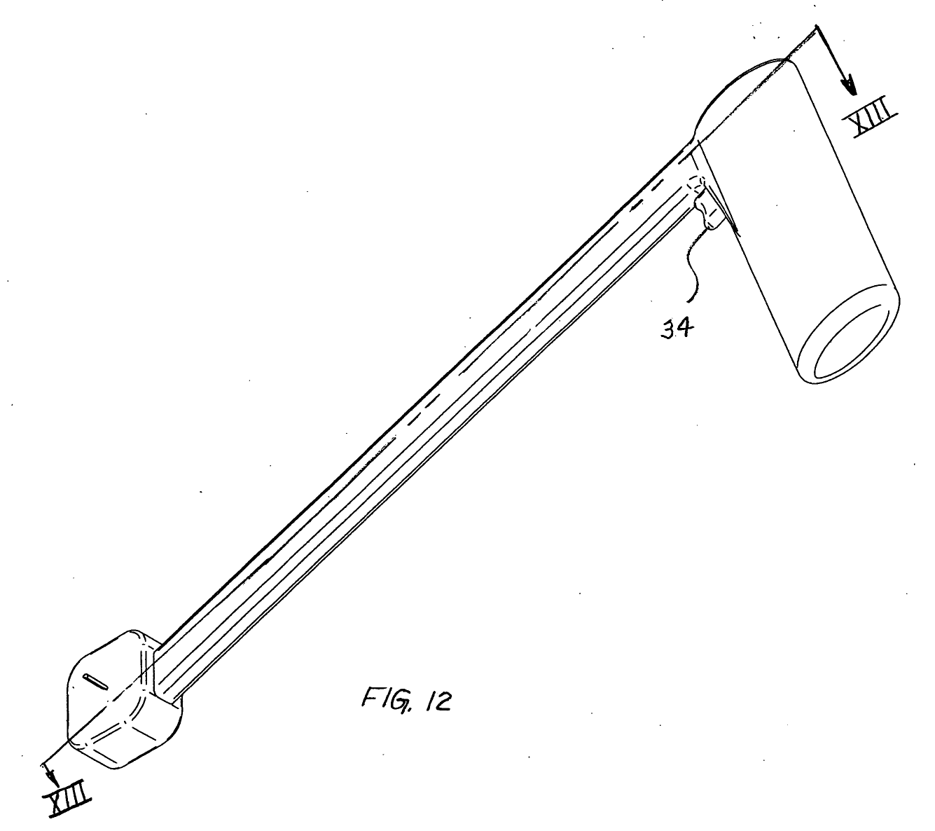

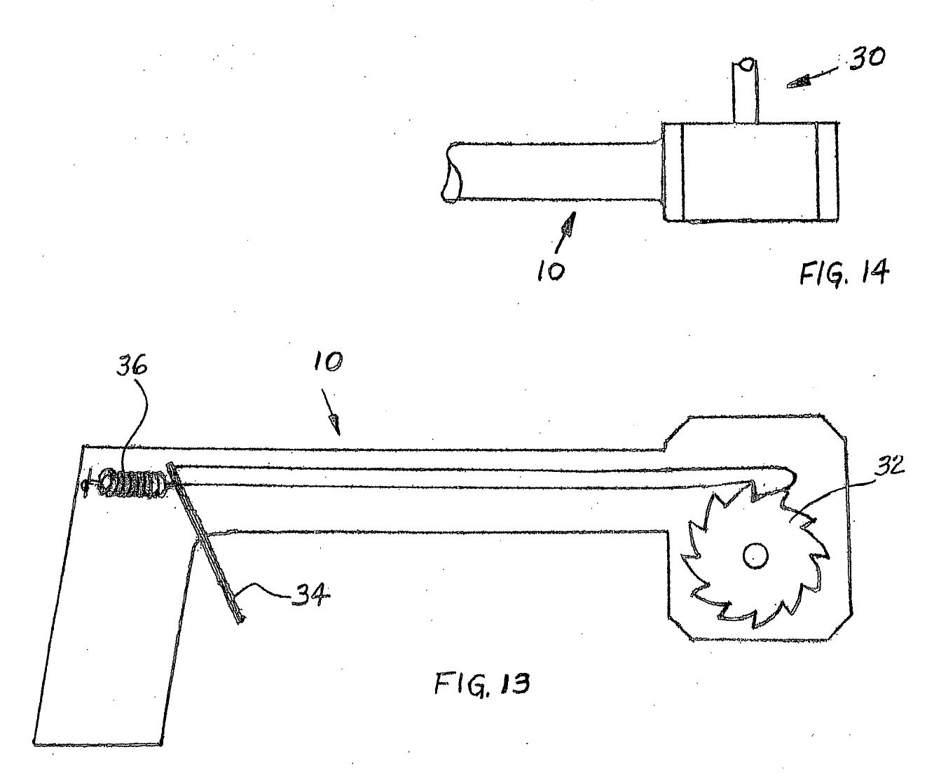

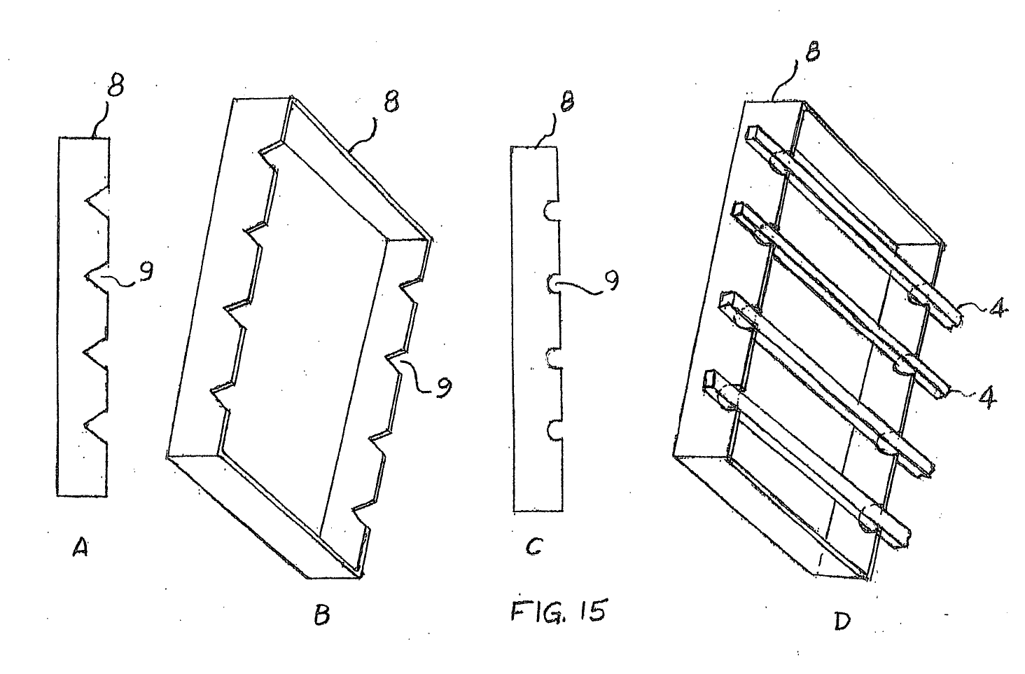

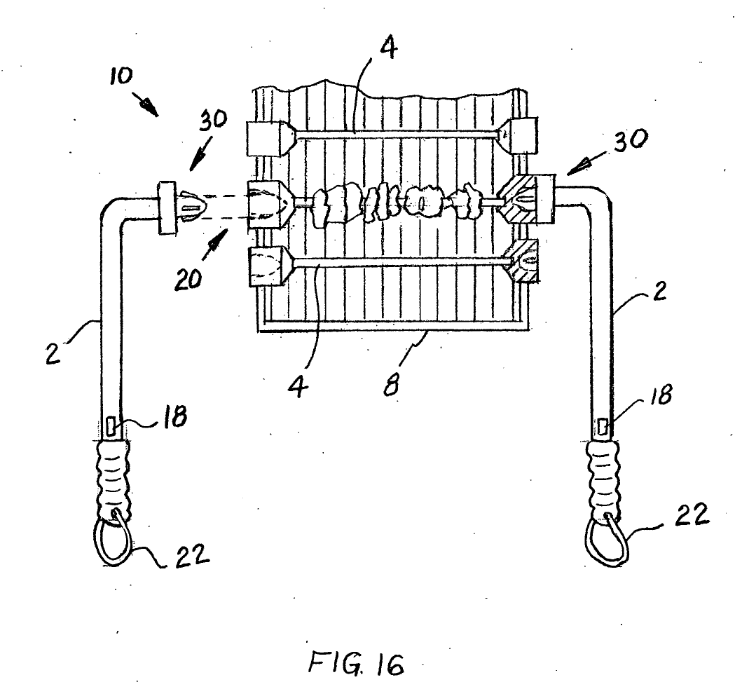

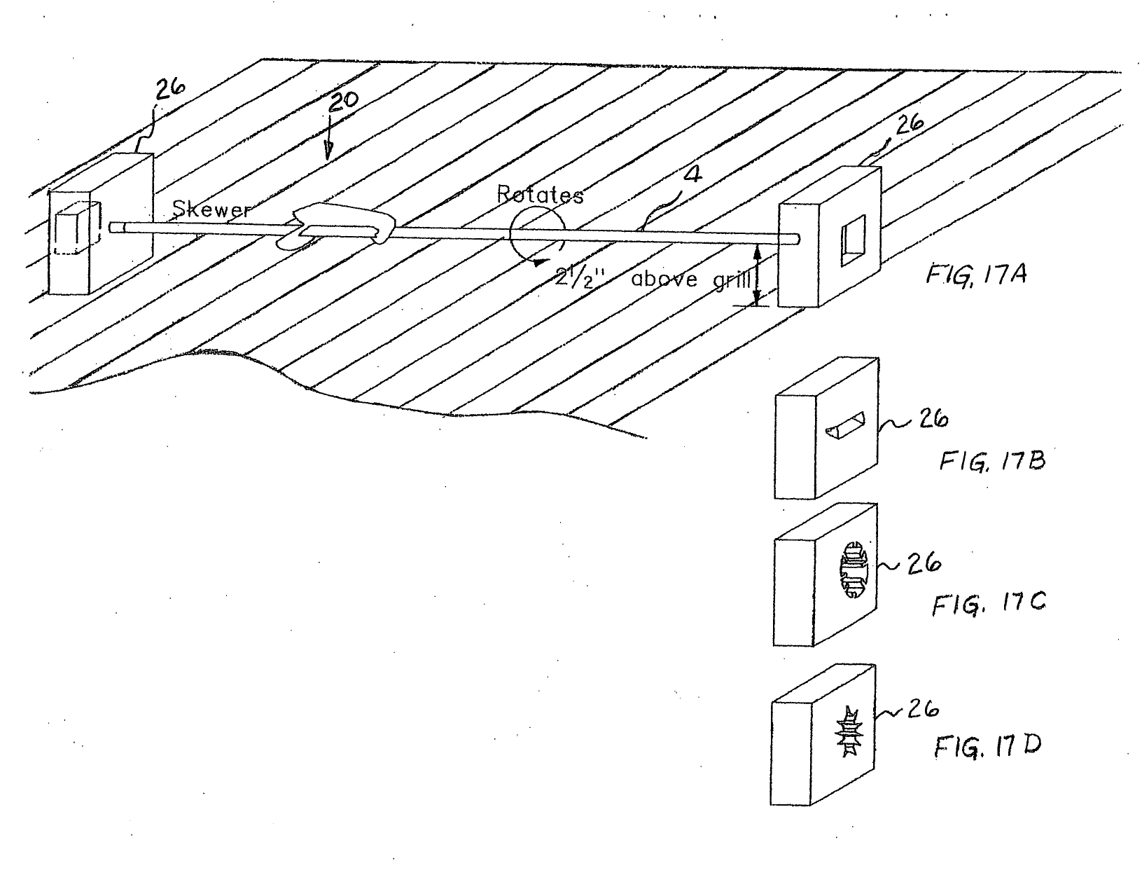

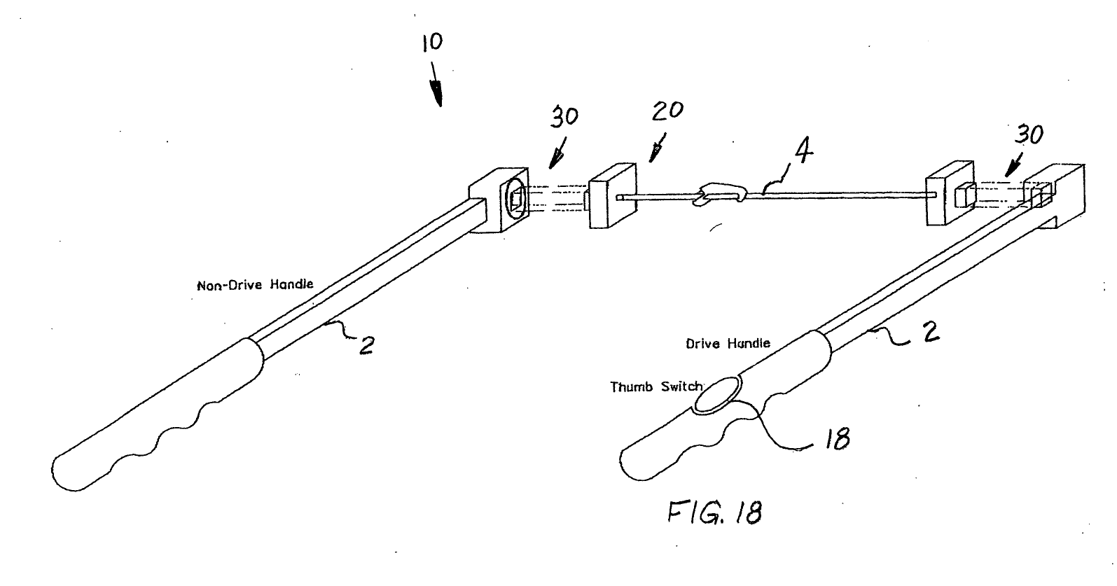

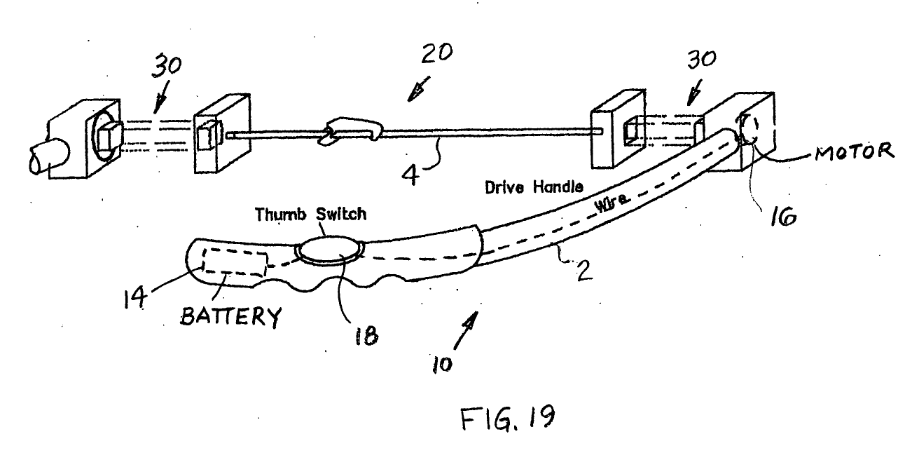

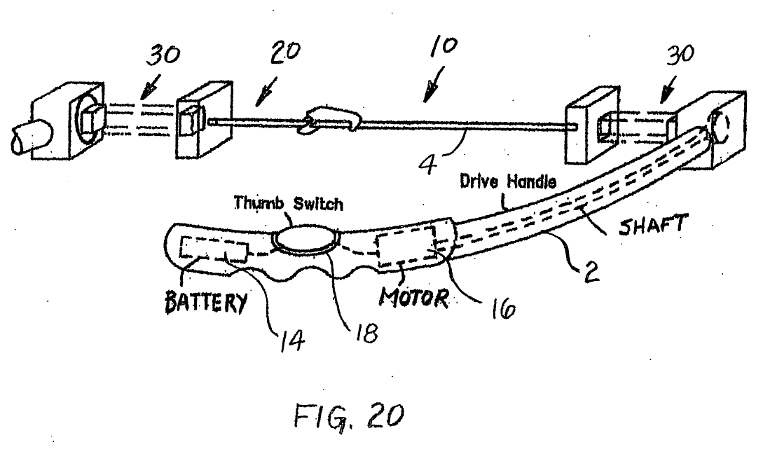

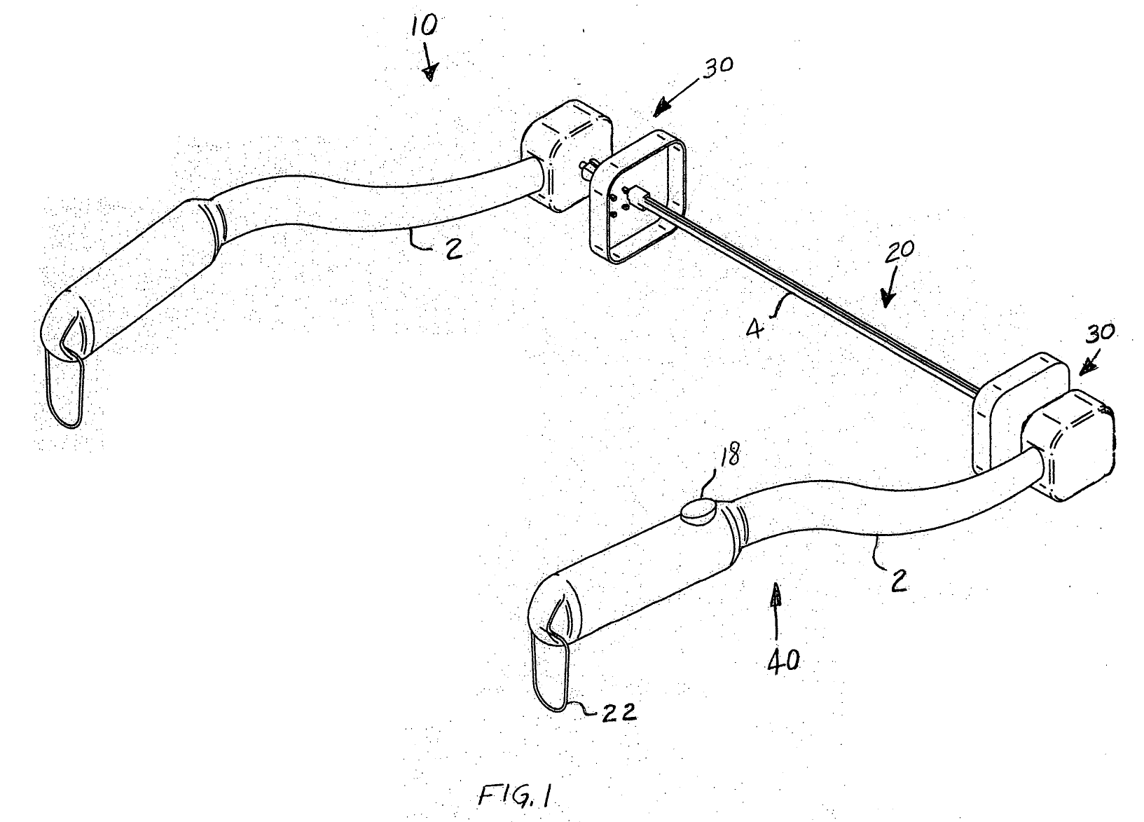

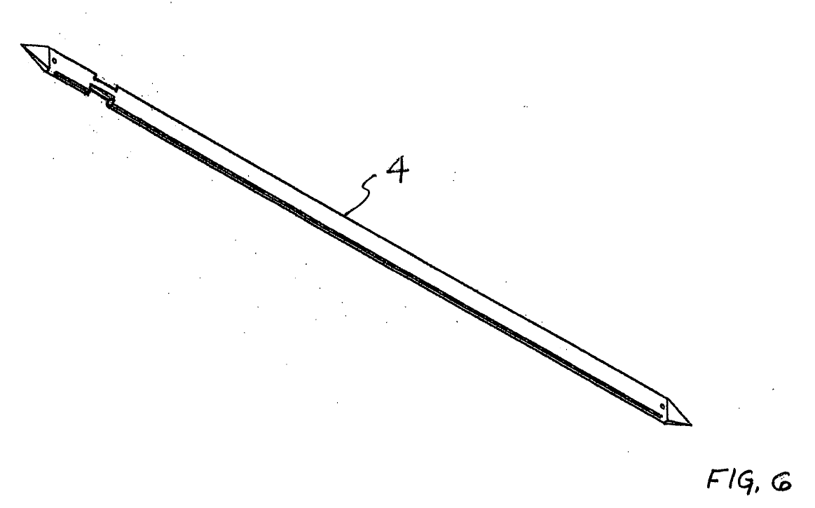

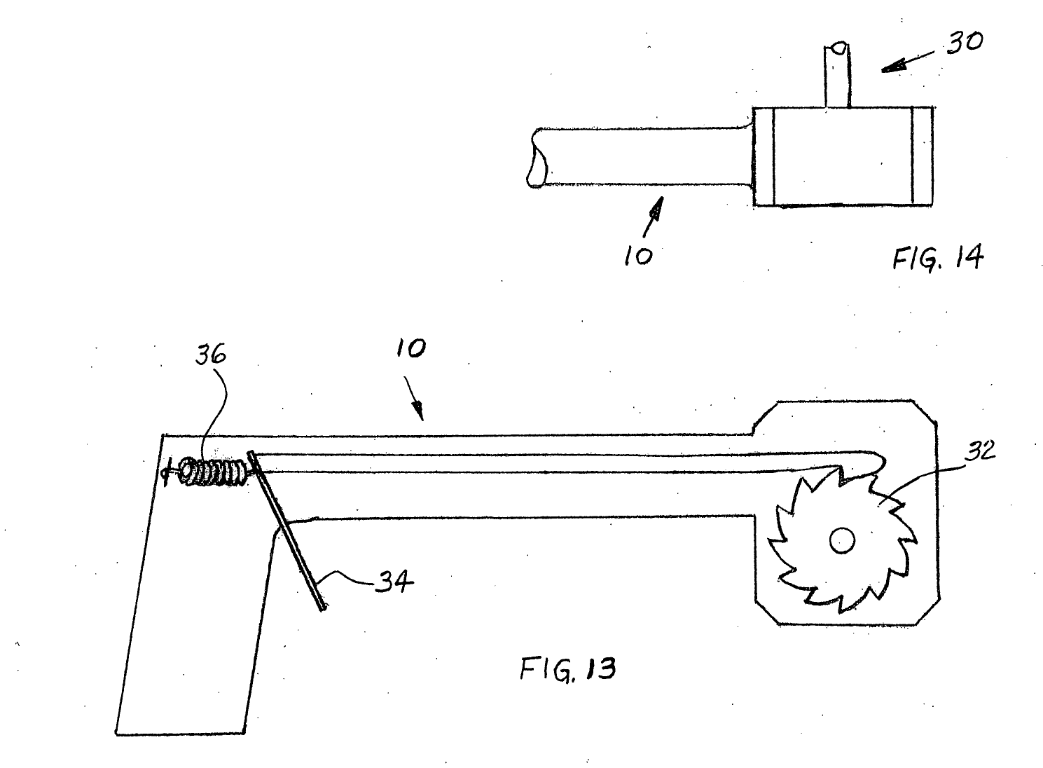

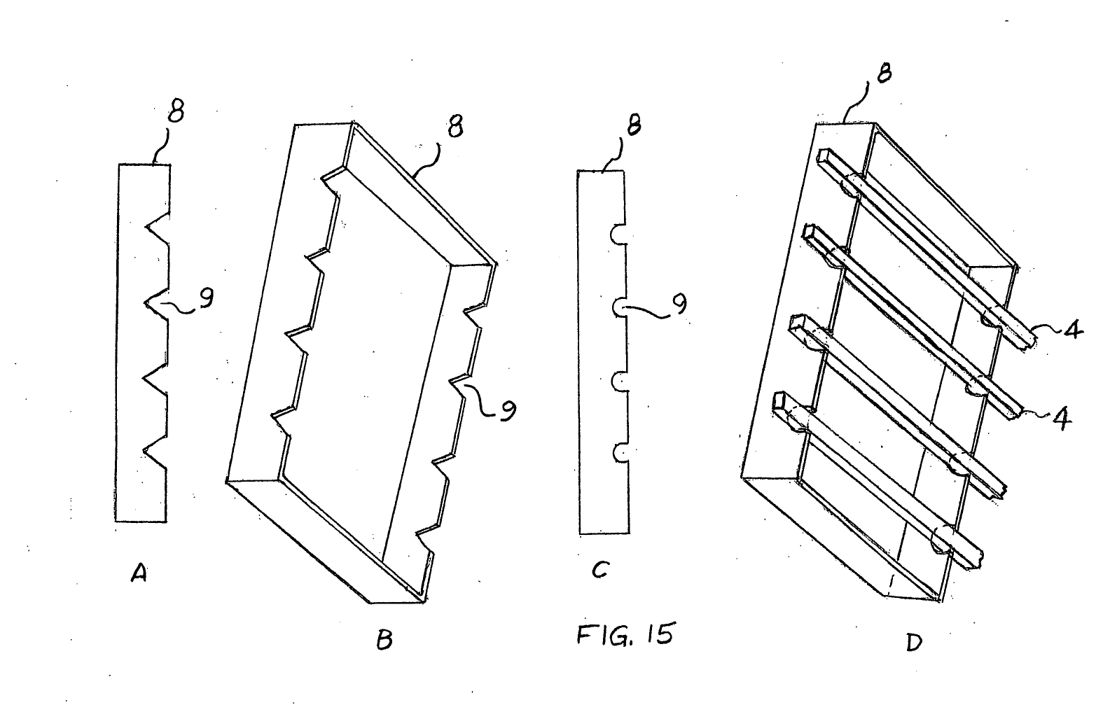

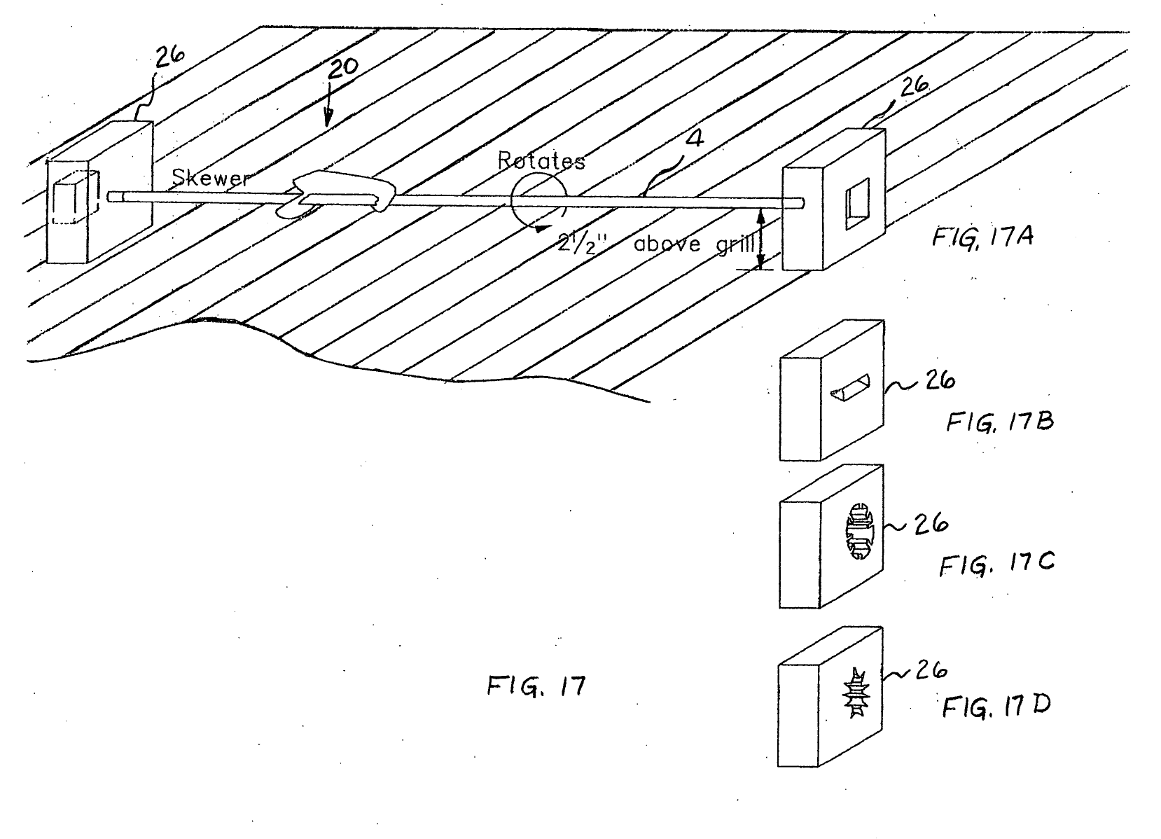

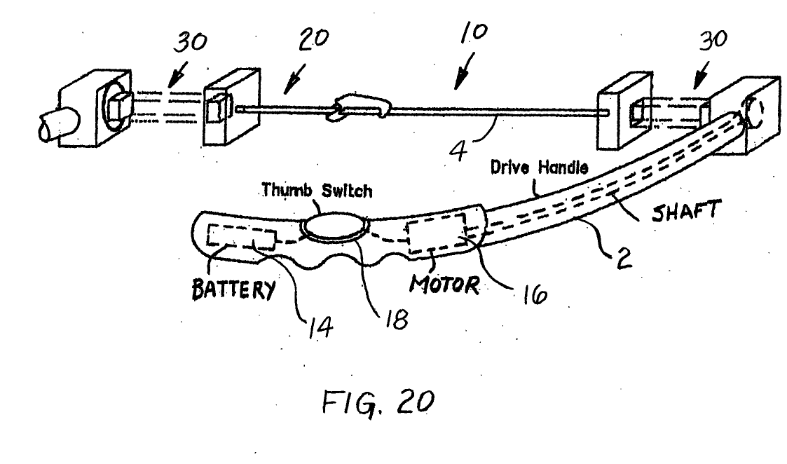

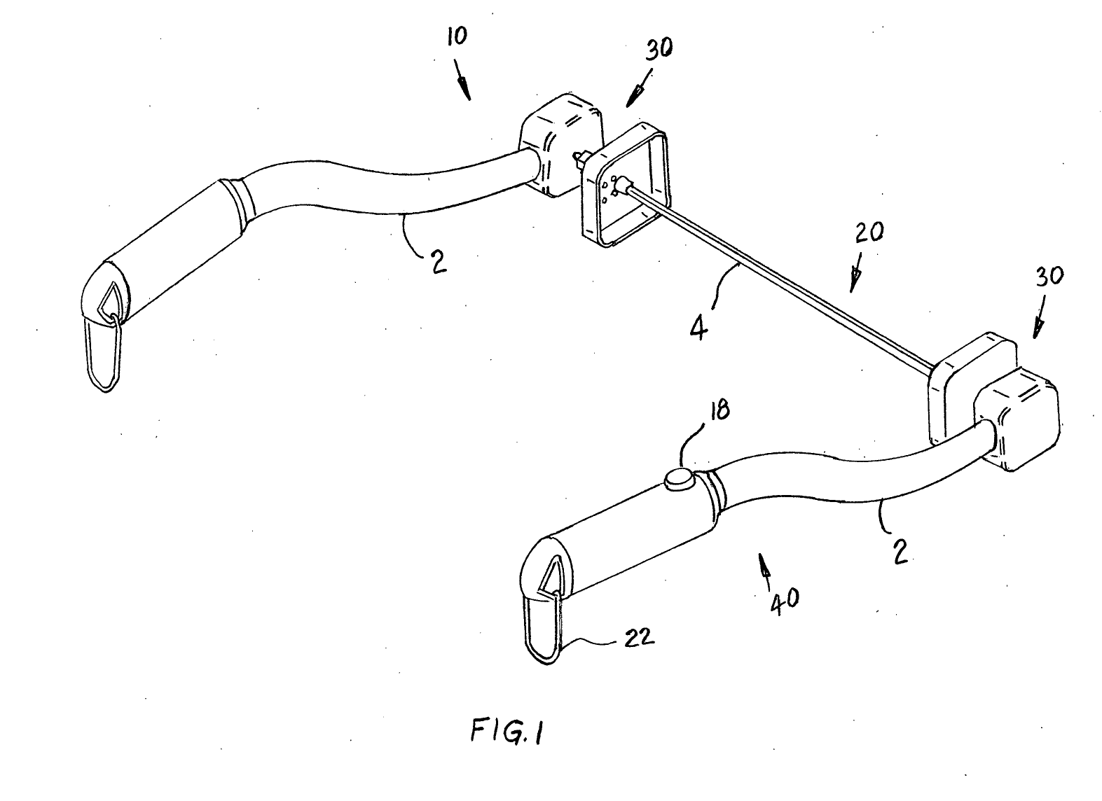

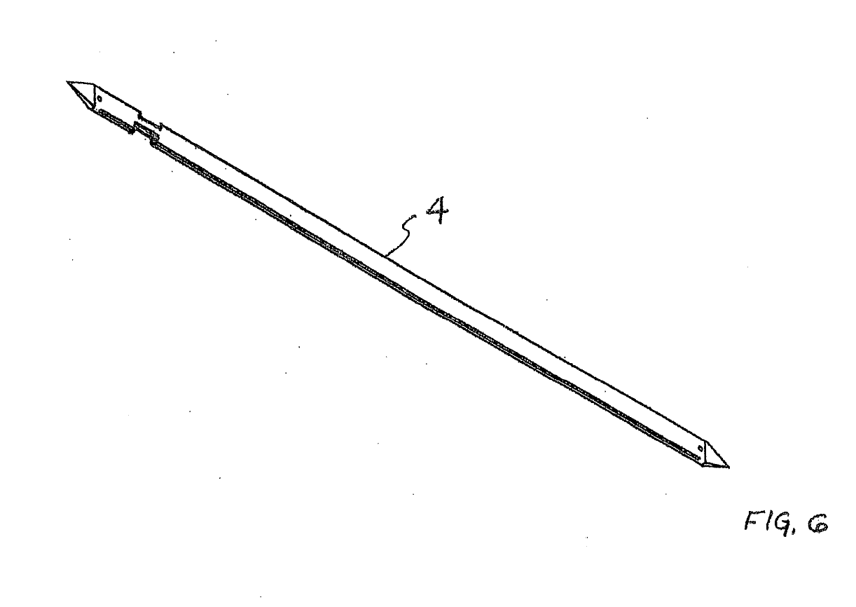

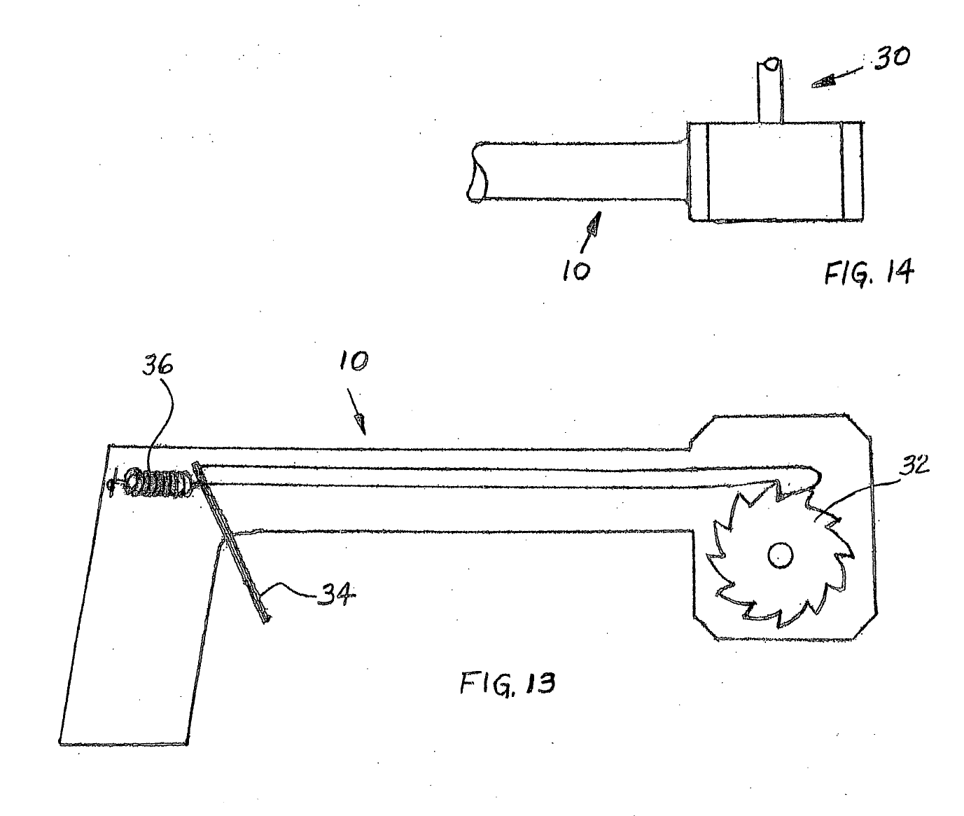

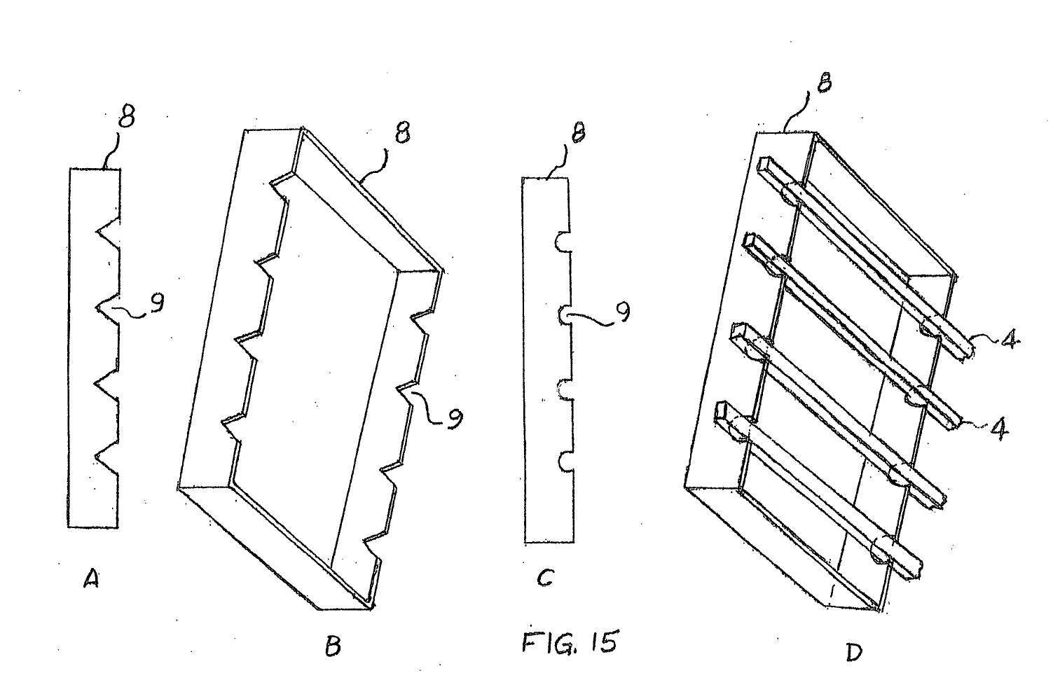

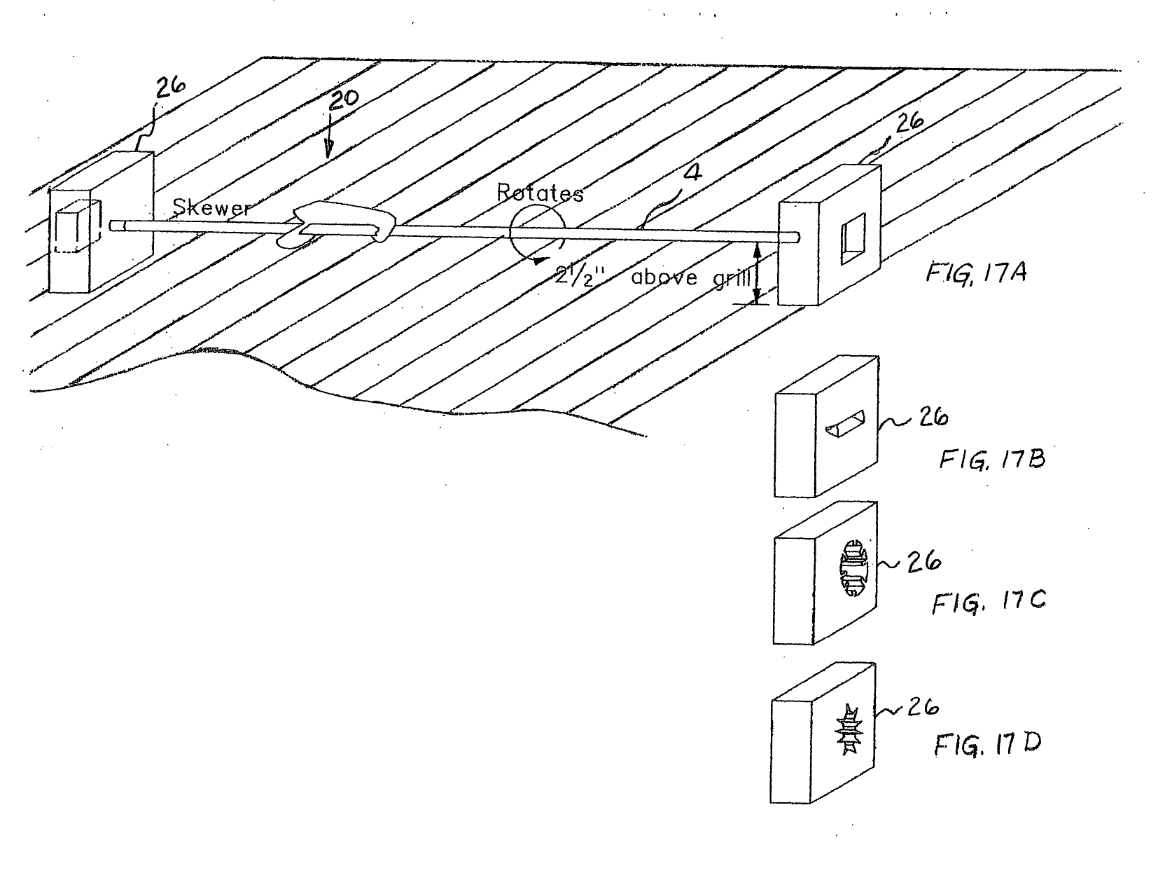

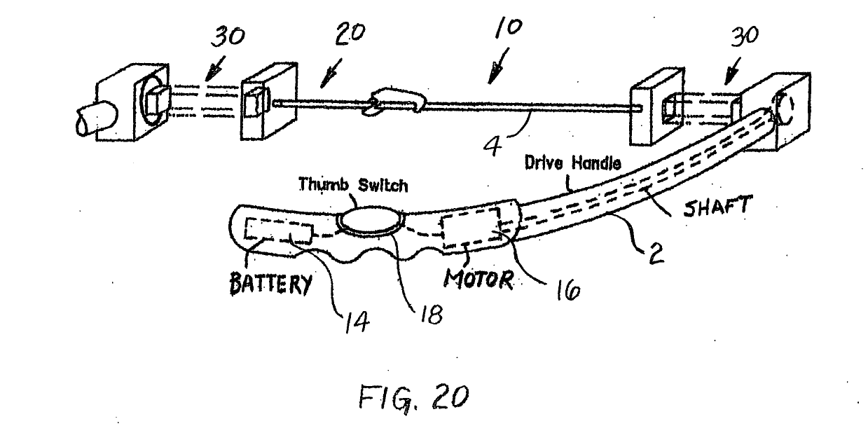

FIGS. 12-14 show the embodiment of the invention where the food containing member 20 is rotated by a mechanical means 12. In this embodiment the means 12 includes a ratchet 32 that is controlled by a trigger/switch mechanism 34. Such trigger/switch mechanism 34 can be either as shown in FIG. 12 or in FIG. 13. The trigger/switch mechanism 34 is biased by means of a spring 36. Although the mechanical means only shows a ratchet 32, it is within the scope of the invention that such other methods of rotating the food containing member 20 would include but are not limited to gears, chains, pulley, crank, Geneva stop mechanism, and rack and pinion.

In a second aspect here is provided an apparatus 10 for at least one of supporting, containing and rotating a pre-selected food product. The apparatus 10 comprises a rod like member 4 having each of a first predetermined shape and a first predetermined length for one of receiving such pre-selected food product thereon, such rod like member 4 having a fixed end portion and a removable end portion to facilitate placing such pre-selected food product onto the rod like member 4. There is at least one handle member 2 having a second predetermined shape and a second predetermined length and a means 30 engageable with the fixed end portion of the rod like member 4 and a first end of the handle member 2 for removably engaging the at least one handle member 2 with the fixed end of the rod like member 4 for facilitating at least one of placing and removing the rod like member 4 onto and from respectively a heat source and intermittently rotating the rod like member 4 for a predetermined degree over such heat source, the means 30 being power driven by an electrically operated power assist means 40. Such power assist means 40 includes a power source 14 connected to a motor means 16 and a switch means 18 that is connected between the power source 14 and the motor means 16 for supplying and disrupting power to the motor means 16.

Thus, it can be seen from the above discussion that it would be advantageous for persons that do considerable cooking on the grill if there were an apparatus which would hold or contain the food product for cooking and which would provide a safe means for placing, rotating and removing food products from a cooking surface.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for at least one of supporting, containing and rotating a pre-selected food product, said apparatus comprising:
(a) a food contacting member having each of a first predetermined shape and a first predetermined length for one of receiving such pre-selected food product thereon and containing such pre-selected food product therein;
(b) at least one handle member having a second predetermined shape and a second predetermined length; and
(c) a means engageable with a first end of said food contacting member and a first end of said handle member for removably engaging said at least one handle member with said food contacting member for facilitating at least one of placing and removing said food contacting member onto and from respectively a heat source and intermittently rotating said food contacting member for a predetermined degree over such heat source, said means being one of manually operated and power driven.

2. An apparatus, according to claim 1, wherein said food contacting member is rotated by one of a mechanical and electrical power assist means disposed at least one of on and in said handle member for causing rotation of said food contacting member.

3. An apparatus, according to claim 2, wherein said power assist means is electrically operated and said apparatus further includes a power source connected to a motor means and a switch means connected between said power source and said motor means for supplying and disrupting power to said motor means.

4. An apparatus, according to claim 3, wherein said power source is a battery.

5. An apparatus, according to claim 4, wherein said battery is rechargeable.

6. An apparatus according to claim 1, wherein said food contacting member is one of a rod like member, a basket and a combination rod like member and a basket.

7. An apparatus, according to claim 1, wherein said apparatus further includes a frame member having each of a third predetermined length and a first predetermined width for receiving thereon a predetermined plurality of food contacting members to be placed over such heat source.

8. An apparatus, according to claim 7, wherein said frame member includes a predetermined plurality of radially opposed cutouts having a third predetermined shape disposed on each of said frame members along said third predetermined length for receiving a plurality of said food contacting members.

9. An apparatus, according to claim 8, wherein said third predetermined shape of said cutouts is one of U and V-shaped.

10. An apparatus, according to claim 1, wherein said at least one handle member further includes a strap like member attached to a second end thereof for hanging said handle member up when not in use.

11. An apparatus, according to claim 1 wherein said apparatus includes a pair of handle members removably engageable with a respective end of said food contacting member, one of said pair of handle members having a free floating engagement with said respective end of said food contacting member.

12. An apparatus, according to claim 11, wherein said pair of handle members further include a cross member pivotally attached to a second end thereof for assisting in positioning said pair of handle members during engagement of said food contacting member.

13. An apparatus, according to claim 1, wherein said predetermined degree is one of 90, 180 and 270 degrees.

14. An apparatus, according to claim 1, wherein said means engageable with a first end of said food contacting member and a first end of said handle member for removably engaging said at least one handle member with said food contacting member includes at least one block like member for engaging at least one end of said food contacting member in a cavity formed on a first side thereof and at least one of a protrusion and a cavity formed on and in respectively on a radially opposed second side thereof, said at least one of said protrusion and said cavity having a fourth predetermined shape and said handle member includes a mating opposed one of an at least one of a protrusion and a cavity formed on a side thereof and having a substantially identical fourth predetermined shape.

15. An apparatus, according to claim 14, wherein said fourth predetermined shaped is selected from the group consisting of generally conical, rectangular, oval, triangular, hexagonal, star and octagonal.

16. An apparatus, according to claim 15, wherein said fourth predetermined shape is generally conical.

17. An apparatus, according to claim 1, wherein said second predetermined shape is selected from the group consisting of straight, curved and offset.

18. An apparatus, according to claim 1, wherein said food contacting member is a basket member having a fifth predetermined shape, said basket member including a lid portion hingedly connected thereto and a means for retaining said lid member in a closed position during cooking.

19. An apparatus, according to claim 18, wherein said fifth predetermined shape of said basket member is generally rectangular.

20. An apparatus for at least one of supporting, containing and rotating a pre-selected food product, said apparatus comprising:
(a) a rod like member having each of a first predetermined shape and a first predetermined length for one of receiving such pre-selected food product thereon, said rod like member having a fixed end portion and a removable end portion to facilitate placing such pre-selected food product onto said rod like member;
(b) at least one handle member having a second predetermined shape and a second predetermined length; and
(c) a means engageable with said fixed end portion of said rod like member and a first end of said handle member for removably engaging said at least one handle member with said fixed end of said rod like member for facilitating at least one of placing and removing said rod like member onto and from respectively a heat source and intermittently rotating said rod like member for a predetermined degree over such heat source, said means being power driven by an electrically operated power assist means, said power assist means including a power source connected to a motor means and a switch means connected between said power source and said motor means for supplying and disrupting power to said motor means.
